(19) United States
(12) Patent Application Publication
(10) Pub. No.: US 2009/0155544 A1
(43) Pub. Date: Jun. 18, 2009

(54) WEB-LIKE ELECTRODE MATERIAL AND METHOD FOR PRODUCING SAME

(75) Inventors: Taku NAKAMURA, Kanagawa (JP); Hiroshi Arakatsu, Kanagawa (JP); Tomomi Tateishi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/332,948

(22) Filed: Dec. 11, 2008

(30) Foreign Application Priority Data
Dec. 12, 2007 (JP) 2007-321297

(51) Int. Cl. H01R 43/00; B32B 3/00

(52) U.S. Cl. 428/189; 427/77

(57) ABSTRACT

A web-like electrode material comprising a web-like substrate, an electrode layer and a functional layer provided in that order, wherein a plurality of electrode layers are disposed in series with blanks kept remaining in both side edges in the cross direction of the substrate and in the longitudinal direction thereof each with a predetermined regularity, and the functional layer is disposed by continuous coating in the longitudinal direction of the substrate, and a part of each electrode layer is laid bare.

### BACKGROUND OF THE INVENTION

1. Field of the Invention

The present invention relates to a web-like electrode material, to an electrode material to be produced by cutting the web-like electrode material, to an electronic device comprising the electrode material, and to a method for producing the web-like electrode material.

2. Description of the Related Art

Heretofore known are some methods for laminating an electrode layer and a functional layer on a substrate to thereby provide thereon an area where the electrode layer is laid bare and an area where the functional layer is disposed on the electrode layer.

One method comprises applying a ultraviolet (UV)-curable resin layer (photoresist) onto the entire surface of an electrode layer, then pattern-wise exposing it to UV rays via a mask, developing it to thereby make the resin layer remain only on the electrode layer to be laid bare, then uniformly forming a functional layer thereon by coating, and finally washing away the resin layer on the electrode layer to thereby lay the electrode layer bare.

Another method comprises forming a functional layer on the entire surface of an electrode layer by coating, applying a photoresist onto the entire surface of the functional layer, then pattern-wise exposing it, peeling away the resist on the part of the functional layer to be removed to thereby lay the functional layer bare, then dissolving and removing the functional layer in the part, and thereafter peeling away the remaining resist to form a patterned functional layer.

However, these methods require many step, in which, in addition, a mask is disposed on the coating layer (photoresist layer or functional layer) on the electrode layer for exposure to light and the process inevitably requires a sheet-feeding processing operation, and therefore, the methods are unsuitable to low-cost mass-production plants. Further, when the functional layer is dissolved and removed away, there occurs a problem in that, in the dissolution step, the underlying electrode layer may be damaged and the functional layer may partly remain still undissolved. In addition, there may occur other problems in that the resist could not be completely peeled away and the dissolved resist may contaminate the surface of the processed structure. Owing to these problems, the properties of the products may be deteriorated, the quality stability thereof may be lowered and the reliability thereof may be lowered.

Various investigates have been made to overcome the above-mentioned problems.

For example, JP-A 2001-73193 discloses a method for forming an insulating resin layer on the surface of an electrode layer through electrodeposition. According to the method described in JP-A 2001-73193, a functional layer may be provided selectively only on an electrode layer through electrodeposition using an electrode pattern; however, in the method, it is in fact impossible to lay a part of an electrode layer bare and to provide a functional layer on the electrode layer, and to produce the structure as a continuous web.

JP-A 2000-185254 describes a multilayer coating system that uses plural die-type coating units; JP-A 2004-25002 describes a coating apparatus for simultaneous multilayer coating to form at least two layers, using an extrusion-type coater head; JP-A 2003-117463 describes a multilayer coating apparatus for slide coating or curtain coating, using a multilayer coating die. However, JP-A 2000-185254, JP-A 2004-25002 and JP-A 2003-117463 have no description relating to a method of providing a functional layer selectively on an electrode layer except the part thereof kept bared (generally, the part corresponding to a lead electrode); and in these, it is in fact impossible to provide plural functional layers with keeping a part of electrode laid bare.

JP-A 11-119451 describes a dip-coating apparatus for production of electrophotographic photoreceptors. The apparatus makes it possible to form a functional layer on the entire surface of an electrode layer, in which, however, it is extremely difficult and is, in fact, impossible to form a functional layer with keeping a part of electrode laid bare.

JP-A 2007-12878 describes a method for forming a functional layer only in a hydrophilic region, which comprises previously forming a hydrophilic/hydrophobic region on a support by stamping, and then applying a coating solution for a functional layer onto the entire surface thereof. However, the method requires use of a strong alkali for attaining the effect of stamping, but an electroconductive material such as ZnO, ITO, Al, Ag or the like generally used for electrode layer is poorly resistant to alkali and is therefore hardly applicable to the method.

Further, in case where a functional layer is laminated on a continuous web, the film thickness is generally thick at the edges of the web; and therefore, the width of the upper functional layer is made narrower than that of the lower functional layer. In such a lamination mode, however, the functional layers are not laminated at the edges of the web, and therefore, the area from the bare electrode to the part where only a part of plural functional layers are formed could not function as a display element, and only a display device that wears a thick frame could be obtained.

Specifically, the sheet-feeding process of using a photoresist or the like in production of an electrode material, which has an electrode layer and a functional layer formed in that order on a substrate and has an area where the electrode layer is laid bare and an area where the functional layer is formed on the electrode layer, is complicated in point of the constitutive steps and its production efficiency is poor, and according to the process, it is difficult to produce large-area devices on a mass-production scale; and in addition, the products fluctuate in point of their properties therefore causing the reduction in the quality stability and the reliability of the products.

In forming a functional layer on an electrode layer, a substantially web-like electrode material could not be produced according to the above-mentioned continuous coating method.

In addition, when web-like electrode material produced according to the conventional continuous coating method is cut for use as an electrode material, it requires a step of baring the electrode layer; and since the electrode layer is smaller than the functional layer, it shall have a useless area around it, and there may occur another problem in that the facing electrodes may short-circuit via the cut face thereof.

### SUMMARY OF THE INVENTION

An object of the invention is to produce a web-like electrode material having an area where an electrode layer is laid bare and an area where at least one functional layer is disposed on the surface of the electrode layer, according to a simple, continuous coating process.

Another object is to provide a web-like electrode material having uniform accuracy.

Still another object is to provide a web-like electrode material capable of giving, as a cut electrode material, a sheet-type electrode material not having a bare electrode edge face that may cause electrical trouble such as short-circuiting, etc.

Given the situation as above, the present inventors have assiduously studied and, as a result, have found that the following means can solve the above-mentioned problems in the present invention.

(1) A web-like electrode material comprising a web-like substrate, a plurality of electrode layers and a functional layer provided in that order, wherein:

the plurality of electrode layers are disposed in series with blanks kept remaining in both side edges in the cross direction of the substrate and between adjoining electrode layers in the longitudinal direction of the substrate each with a predetermined regularity, and

the functional layer is disposed to cover a part of each electrode layer and leave the other part of each electrode layer bare.

(2) The web-like electrode material of (1), wherein the plurality of electrode layers have the same shape.

(3) The web-like electrode material of (1) or (2), wherein the electrode layer has a shape composed of a nearly rectangular part and a projection continuing from the nearly rectangular part, and wherein the functional layer is so disposed that at least a part of the projection is kept bare.

(4) The web-like electrode material of (3), wherein the functional layer completely covers the electrode layer except the projection thereof.

(5) The web-like electrode material of any one of (1) to (4), wherein the electrode layers are disposed at intervals of from 1 to 300 mm in the longitudinal direction of the substrate.

(6) The web-like electrode material of any one of (1) to (5), wherein the electrode layers are disposed with a blank of at least 5 mm each in both side edges in the cross direction of the substrate.

(7) The web-like electrode material of any one of (1) to (6), wherein the electrode layer is composed of a nearly rectangular part of 10 to 3000 mm×5 to 2000 mm, and a nearly rectangular projection of 1 to 300 mm×2 to 200 mm continuing from it.

(8) The web-like electrode material of any one of (1) to (7), wherein the functional layer is provided according to a wet coating process.

(9) The web-like electrode material of any one of (1) to (8), wherein at least two functional layers are provided.

(10) The web-like electrode material of (9), wherein at least two functional layers are provided by simultaneous coating.

(11) The web-like electrode material of (9) or (10), wherein the width of at least two functional layers is nearly the same.

(12) An electrode material produced by cutting the web-like electrode material of any one of (1) to (11) between the electrode layers in the cross direction of the substrate.

(13) An electrode produced by providing at least an electrode layer on the surface of the functional layer of the electrode material of (12).

(14) An electronic device comprising the electrode material of (12) or the electrode of (13).

(15) The electrode device of (14), which is a display device or a solar cell.

(16) A method for producing a web-like electrode material comprising a web-like substrate, a plurality of electrode layers and a functional layer provided in that order, which comprises disposing plural electrode layers in series with blanks kept remaining in both side edges in the cross direction of the substrate and between the adjoining electrode layers in the longitudinal direction (machine direction) thereof each with a predetermined regularity, and disposing the functional layer by continuous coating in the longitudinal direction of the substrate so as to keep a part of each electrode layer laid bare.

(17) The method of (16), wherein the plurality of electrode layers have the same shape.

(18) The method of (16) or (17), wherein the electrode layer has a shape composed of a nearly rectangular part and a projection continuing from the nearly rectangular part, and wherein the functional layer is so disposed that at least a part of the projection is kept bare.

(19) The method of (18), wherein the functional layer is formed to completely cover the electrode layer except the projection thereof.

(20) The method of any one of (16) to (19), wherein the electrode layers are disposed at intervals of from 1 to 300 mm in the longitudinal direction of the substrate.

(21) The method of any one of (16) to (20), wherein the electrode layers are disposed with a blank of at least 5 mm each in both side edges in the cross direction of the substrate.

(22) The method of any one of (16) to (21), wherein the electrode layer is composed of a nearly rectangular part of 10 to 3000 mm×5 to 2000 mm, and a nearly rectangular projection of 1 to 300 mm×2 to 200 mm continuing from it.

(23) The method of any one of (16) to (22), wherein the functional layer is provided according to a wet coating process.

(24) The method of any one of (16) to (23), wherein at least two functional layers are provided.

(25) The method of (24), wherein at least two functional layers are provided by simultaneous coating.

(26) The method of (24) or (25), wherein the coating width of at least two functional layers is nearly the same.

(27) The method of any one of (16) to (26), wherein the functional layer is formed by bar-coating to be attained by the use of a suction unit capable of drawing out the superfluous coating liquid at the edges of the substrate in accordance with the coating width of the layer.

(28) The method of any one of (16) to (26), wherein the functional layer is formed by bar-coating to be attained by the use of a step roll.

(29) The method of any one of (16) to (28), wherein the electrode layers are provided by patterning.

(30) The method of any one of (16) to (28), wherein the electrode layers are provided by coating.

(31) The method of any one of (16) to (30), wherein the web-like electrode material is a web-like electrode material of any one of (1) to (11).

The present invention has made it possible to produce a web-like electrode material having, on a substrate, a part of a bare electrode layer, and a part of at least one functional layer laminated on the surface of the electrode layer, according to a simple production method of continuous coating. The web-like electrode material of the invention has uniform accuracy. As a result, the invention has made it possible to provide an inexpensive electrode material having excellent performance and uniformity.

### BRIEF DESCRIPTION OF THE DRAWINGS

FIG. 1 is a schematic view showing a web-like electrode material of the invention.

FIG. 2 is a schematic view showing the relationship between the web-like electrode material of the invention and the position at which the material is cut.

FIG. 3 is a schematic view showing the relationship in point of the lamination position between the electrode material of the invention and a counter electrode.

FIG. 4 is a schematic view showing a slide bead coater used in simultaneous multilayer coating in an example of the invention.

### BEST MODE FOR CARRYING OUT THE INVENTION

The contents of the invention are described in detail hereinunder. In this description, the numerical range expressed by the wording “a number to another number” means the range that falls between the former number indicating the lowermost limit of the range and the latter number indicating the uppermost limit thereof.

The web-like electrode material of the invention comprises a web-like substrate, a plurality of electrode layer and a functional layer provided in that order, and is characterized in that the plurality of electrode layers are disposed in series with blanks kept remaining in both side edges in the cross direction of the substrate and between the adjoining electrode layers in the longitudinal direction of the substrate each with a predetermined regularity, that the functional layer is disposed to cover a part of each electrode layer and leave the other part of each electrode layer bare.

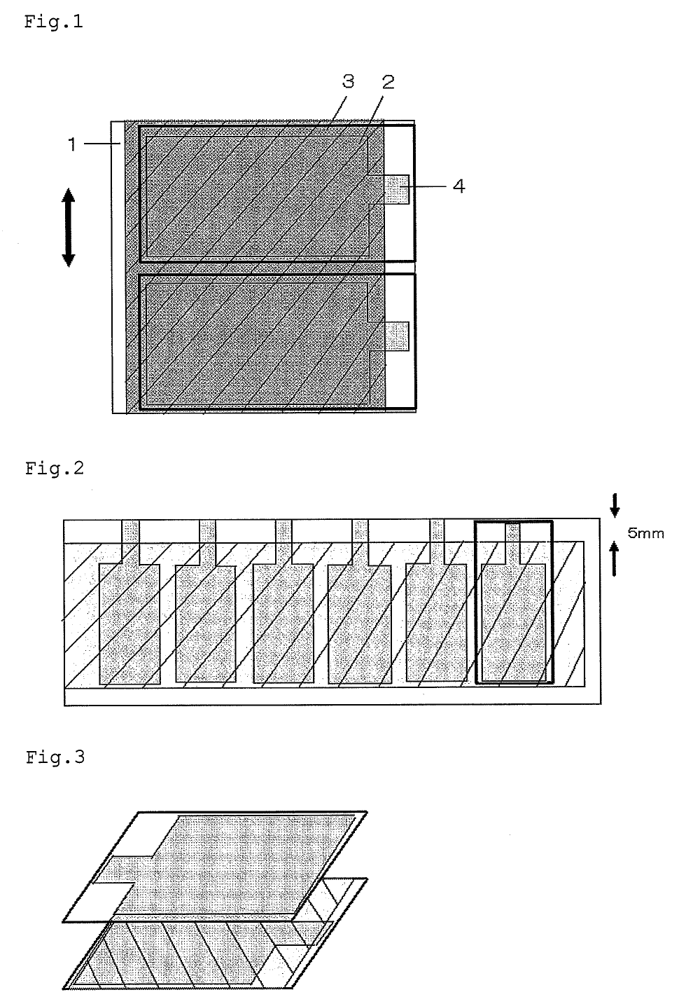

FIG. 1 shows one example of the web-like electrode material of the invention, wherein electrode layers 2 are provided on a web-like substrate 1 and a functional layer 3 is thereon by continuous coating. In FIG. 1, slanted lines are given to the part of the functional layer. (The same shall apply to FIG. 2 and FIG. 3.) The arrow in FIG. 1 indicates the coating direction in forming the functional layer.

In the web-like electrode material of the invention, the electrode layers are so disposed as to keep blanks remaining in both side edges in the cross direction of the substrate and in the longitudinal direction thereof each with a predetermined regularity. Since the electrode layers are so disposed as to keep the blanks remaining with such a predetermined regularity, they may be completely covered with the functional layer applied thereover except the part of the projection 4 of each electrode layer; and therefore, the web-like electrode material can effectively prevent troubles such as short-circuiting and current leakage. Another advantage of the web-like electrode material is that the accuracy and the quality of the constitutive members are stable.

As formed by continuous coating, the functional layer may be uniform and, as a result, the web-like electrode material thus produced comprises uniform electronic devices connected to each other in series. Specifically, the electrodes to be obtained by cutting the web-like electrode material of the invention may have uniform quality. In FIG. 1, the area surrounded by the thick line indicates one example of cutting the web-like electrode material. Only by cutting the web-like electrode material in that manner, a large number of electrodes can be produced on a mass-production scale.

The part where the electrode layer is laid bare (projection) is meant to indicate the part of the electrode layer of which the surface is not covered with any other layer such as the functional layer or the like but is laid bare outside.

The blanks in the cross direction of the substrate are, for example, the blanks having a predetermined width in the side edges in the cross direction of the substrate, as in FIG. 1, preferably having a width of at least 5 mm, more preferably at least 10 mm. The uppermost limit of the width may be, for example, at most 50 mm. The blanks of at least 5 mm thus provided may facilitate more the formation of the overlying functional layer to completely cover the electrode layers. As in FIG. 1, one side edge in the cross direction of the substrate may vary depending on the shape of the projection of the electrode layer, and in this case, the part having a narrowest width of the side edge is considered as the above-mentioned width thereof.

On the other hand, the blanks in the longitudinal direction of the substrate are provided preferably at intervals of from 1 to 300 mm, more preferably from 5 to 100 mm. In general, the electrode layers are disposed on the substrate in parallel to the cross direction of the substrate.

The coating direction of the functional layer is preferably the longitudinal direction and perpendicular to the cross direction as referred to herein. However, “perpendicular” as referred to herein may not be strictly at 90°, and it may include some error range not overstepping the spirit and the scope of the invention.

In the invention, a web-like substrate is used to produce the web-like electrode material. The term “web-like” as referred to herein includes sheet and film, preferably rectangle sheet and film having a longitudinal direction and a cross direction. The long side is longer than the width preferably by at least two times (for example, at least 10 times, at least 100 times, at least 1000 times). The sheet and film may be rolled up.

The material and the size of the substrate for use in the invention may be determined suitably, depending on the use thereof, etc. For the substrate for use in the invention, usable are various base plates or films. When the substrate is a resin base plate or a resin film, examples of the resin material include polyester resin such as polyethylene terephthalate and polybutylene terephthalate; polyolefin resin such as polyethylene and polypropylene; polystyrene resin; acrylate resin such as polymethyl methacrylate; and polyvinyl alcohol resin, polyvinyl butyral resin, polysulfone resin, polyether sulfone resin, polycarbonate resin, polyimide resin, epoxy resin, etc. The substrate may be formed of a composite material of two or more such resins. Commercial electrode-fitted substrates may also be used herein.

Not specifically defined, the thickness of the substrate may be such that it satisfies the mechanical strength, the light weight and the thinness required depending on its use. In general, a resin base plate having a thickness of from 100 to 1500 μm or so, or a resin film having a thickness of from 10 to 250 μm or so is used. The substrate may be from 1 to 2400 mm long in the cross direction thereof.

In FIG. 1, the electrode layers have the same shape; however, in the invention, they may not always have the same shape. In case where electrode layers having different shapes are sued, they must be disposed with a predetermined regularity. Specifically, they are patterned. Providing the electrodes with such a predetermined regularity may lower the cost in cutting the web-like electrode material into individual electrode materials.

The material of the electrode layer for use in the invention is preferably a metal or a metal oxide (including alloys). Preferred examples of the material include metals such as platinum, gold, silver, copper, palladium, indium, tin, aluminium, titanium and zinc, and their alloys; and metal oxides such as zinc oxide, ITO and IGZO. Also preferred for use herein is a conductive polymer, and its examples include poly(3,4-ethylenedioxythiophene)-poly(4-styrenesulfonate), polyaniline, polypyrrole, polyacene, polythiophene, etc. More preferred are poly(3,4-ethylenedioxythiophene)-poly(4-styrenesulfonate) and polyaniline. One or more of these may be used either singly or as combined. Preferably, the thickness of the electrode layer is from 0.05 to 50 μm.

The shape and the size of the electrode layer may be determined suitably, depending on the use thereof. For example, when the electrode layer has a nearly rectangular part and a projection continuing from it, as in FIG. 1, then the nearly rectangular part preferably has a size of 10 to 3000 mm×5 to 2000 mm. The rectangular part includes a square. The wording “nearly rectangular” means that the shape may include not only a rectangle in the narrow sense of the word but also any other deformed ones within a range not overstepping the spirit and the scope of the invention. The shape of the projection is preferably nearly rectangular, but may be any other shape than it. Preferably, the size of the projection is 1 to 300 mm×2 to 200 mm.

In the invention, the electrode layers may be provided by printing, patterning or coating. An electrode-fitted base plate may also be used. In case where the electrode layers are provided by coating, preferably employed is a bar coating method, a die coating method or a screen printing method as in WO2005/041217.

In the invention, the functional layer is provided by continuous coating in the longitudinal direction of the substrate, and is so provided that a part of the electrode layer could be kept bare. In general, as in FIG. 1, the functional layer is preferably so provided that at least a part of the projection of the electrode layer could be kept bare. Also preferably, the functional layer is so provided that the electrode layer except the projection is completely covered with it. Specifically, it is desirable that the functional layer is so provided as to cover the cross section and others of the electrode layer.

The material of the functional layer is described. In case where the electrode material is used for a reflection-type display device, preferred for the functional layer are microcapsules prepared by encapsulating a dispersion of electrophoretic particles dispersed in a non-polar solvent, microcapsules prepared by encapsulating a cholesteric liquid crystal, and also photochromic materials, electrochromic materials, etc. In case where the electrode material is used for a solar cell or an organic EL device, preferred for the functional layer are charge transporting materials, electron transporting materials, blocking (insulating) materials, barrier materials for blocking out oxygen and moisture, P or N-type semiconductor materials, semiconductor materials, dye-sensitized titanium oxide porous materials, etc. One or more such functional layers may be provided. The thickness of the functional layer may vary, depending on the function of the layer, but is preferably from 0.1 to 100 μm.

Preferably, the functional layer is so provided by coating that blanks of from 5 to 50 mm wide could remain in the cross direction of the substrate.

In the invention, the functional layer is preferably provided according to a wet coating method, more preferably according to a bar coating method, a die coating method, a gravure coating method or a curtain coating method. In case where two or more functional layers are provided, they may be formed by successive coating, or by simultaneous multilayer coating. Preferably, they are formed by simultaneous multilayer coating. Simultaneous multilayer coating is favorable, since the coating width of the plural, two or more functional layers formed could be the same. Preferably, the coating width of the plural, 2 or more functional layers is nearly the same. The wording “nearly the same” as referred to herein means that the error of the coating width of the individual functional layers is within ±5%.

For the coating method to prevent the edges of the functional layer from being thickened, for example, the following methods may be employable.

The first coating method comprises using a coating bar of such that the depth of the groove formed on the bar surface is shallower than the depth of the groove formed on the bar surface corresponding to the inside of both side edges thereof, as in JP-A 2007-061709.

The second coating method comprises forming a functional layer in a mode of bar coating or the like and then drawing out the superfluous coating liquid in the area of the side edges of the substrate in accordance with the coating width by the use of a suction unit, as in JP-A 2007-237039, 2007-260512, 56-73579, JP-UM-A 60-49949, JP-A 2-99166, 7-299410 or 2002-66430.

The third coating method comprises bar coating by the use of a step roll. The step roll as referred to herein means a bar having a grooved site and a non-grooved site. The bar of the type is described, for example, in JP-A 11-596, and may be used for forming a web-like, stripe-shaped pattern. In the present invention, the bar may be used to form a functional layer with the bare electrode kept as it is.

In the invention, the functional layer may be formed, having a uniform coating thickness with no thickened side edges, and therefore, the pressure resistance of the display device to be constructed by sticking a counter electrode to the electrode material of the invention can be thereby enhanced, and the device may be free from trouble of electrode breakage or the like.

More preferred embodiments of the invention are (1) a reflection-type display device in which the functional layer is formed with the bare part of the electrode layer kept as such by the use of an ordinary coating rod and a suction unit (encapsulated electrophoretic system); (2) a reflection-type display device in which the functional layer is formed with the bare part of the electrode layer kept as such by the use of a coating rod having a grooved site and a non-grooved site (encapsulated cholesteric liquid-crystal system); (3) a reflection-type display device in which plural functional layers are formed at the same time with the bare part of the electrode layer kept as such by the use of a slide bead coater (encapsulated cholesteric liquid-crystal system); and (4) a reflection-type display device in which the size of the electrode layer is smaller than the cut size of the functional layer (encapsulated cholesteric liquid-crystal system).

### [Electrode Material]

Preferably, the web-like electrode material of the invention is cut for the individual electrode layers in the cross direction thereof to give sheet-like electrode materials for use in the invention. A counter electrode may be stuck to the electrode material to construct an electrode for use herein. FIG. 3 shows a structure of the electrode material of the invention to which a counter electrode is stuck. In FIG. 3, electrode materials each having an electrode layer and a functional layer formed on a substrate are stuck together, therefore giving a combined electrode material having a structure of a substrate, an electrode layer, a functional layer, a functional layer, an electrode layer and a substrate. Depending on the use thereof, however, the counter electrode in the electrode material may be an electrode layer alone, and the electrode layer may be provided by coating or printing. The two members are so stuck that the lead electrode parts thereof could be in opposite directions to each other.

In the electrode material of the invention, the other part than the part where the electrode layer is partly kept bare, or that is, than the part corresponding to the lead electrode is completely covered with the functional layer, and therefore, an electrode may be constructed in a simplified manner by merely sticking the counter electrode layers of the electrode materials, not causing a problem of short-circuiting or the like.

The electrode material of the invention can be widely used as electronic devices. Concretely, it may be used for display devices, solar cells and others, to which, however, the invention should not be limited.

### EXAMPLES

The invention is described more concretely with reference to the following Examples. In the following Examples, the material used, its amount and the ratio, the details of the treatment and the treatment process may be suitably modified or changed not overstepping the spirit and the scope of the invention. Accordingly, the invention should not be limitatively interpreted by the Examples mentioned below.

### Production Example 1

### Production of Polylauryl Methacrylate (P1)

Lauryl methacrylate (51 g) and toluene (50 ml) were put into a 100-ml three-neck flask equipped with a stirrer, a condenser tube and a nitrogen gas inlet tube, and heated up to 70° C. in a water bath with nitrogen gas kept introduced thereinto; and azobisisobutyronitrile (0.26 g) was added to it, and kept stirred and heated for 7 hours to give a viscous polymer solution. The polymer solution was cooled to room temperature, then put into methanol (600 ml) with gradually stirring. A viscous polymer supernatant was removed by decantation, and methanol (100 ml) was again added to it, the supernatant was removed by decantation, and the remaining polymer was dried in vacuum at 40° C. to give polylauryl methacrylate (P1) (46 g).

### Production Example 2

### Production of polylauryl methacrylate-co-N,N,N-trimethyl-N-vinylbenzylammonium chloride (P2)

Lauryl methacrylate (51 g), N,N,N-trimethyl-vinyl-benzylammonium chloride (Qbm, by Seimi Chemical) (4.2 g), toluene (30 ml) and ethanol (20 ml) were put into a 100-ml three-neck flask equipped with a stirrer, a condenser tube and a nitrogen gas inlet tube, and heated up to 60° C. in a water bath with nitrogen gas kept introduced thereinto; and a radical polymerization initiator (V-65, by Wako Pure Chemical Industries) (0.50 g) was added thereto, and kept stirred and heated for 6 hours to give a viscous solution of 56% polylauryl methacrylate-co-N,N,N-trimethyl-N-vinylbenzylammonium chloride (P2).

Production Example 3 and Production Example 4 given below are to demonstrate production of white and black particles, respectively, coated with any of the above polymers.

### Production Example 3

### Production of White Particles (W1)

P1 (9.7 g) produced in Production Example 1 was put into a 100-ml flask, then dissolved in toluene (45 ml), and titanium oxide (R960, by DuPont) (30 g) was added thereto, then ultrasonically treated for 20 minutes to disperse titanium oxide therein, and thereafter this was left overnight at room temperature to thereby make titanium oxide adsorb the polymer P1. The resulting dispersion was put into a centrifugal tube, and centrifuged at 3000 rpm for 20 minutes, then the supernatant was removed by decantation, and the remaining residue was dried in vacuum at 40° C. to give white particles (W1) (19 g).

### Production Example 4

### Production of Black Particles (K1)

The P2 solution (5.5 g) produced in Production Example 2 was put into a 100-ml flask and diluted with 47 ml of toluene, carbon black (Printex A, Degussa Japan) 10 g was added thereto, then ultrasonically treated for 20 minutes to disperse carbon black therein, and thereafter this was left overnight at room temperature to thereby make carbon black adsorb the polymer P2. The resulting dispersion was put into a centrifugal tube, and centrifuged at 3000 rpm for 20 minutes, then the supernatant was removed by decantation, and the remaining residue was dried in vacuum at 40° C. to give black particles (K1) (10 g).

Example 1, Example 2 and Example 3 given below are to demonstrate production of a dispersion, capsules and a display device, respectively, using the polymer-coated particles.

### Example 1

### Preparation of Dispersion of Polymer-Coated Particles

A surfactant (Span 85, by Wako Pure Chemical Industries) (0.01 g) was dissolved in a non-polar solvent (Isopar G, by Exxon) (2.89 g), and the white particles (W1) (2.0 g) produced in Production Example 3 and the black particles (K1) (0.1 g) produced in Production Example 4 were added thereto, and ultrasonically treated for 20 minutes with heating at 40° C. to prepare a dispersion (B1).

### Example 2

### Production of Capsules (C1) of White/Black Dispersion Encapsulated Therein

Gelatin (1.7 g) was put into a 100-ml container equipped with a stirrer, a dropping funnel and a pH meter, then deionized water (31.7 g) was added thereto to dissolve gelatin, and gradually stirred with heating up to 40° C. so as not to engulf bubbles thereinto; and the dispersion (13.3 g) of Example 1 was dropwise added to it through the dropping funnel, taking 15 minutes, and after the addition, this was further kept stirred for 30 minutes.

Next, a solution of gum arabic (1.7 g) dissolved in deionized water (8.2 g) was added to it, then controlled to have a pH of 4 with aqueous 10% acetic acid added thereto, and cooled to 10° C.; and aqueous 25% glutaraldehyde solution (0.8 ml) was added thereto, then slowly restored to room temperature, and kept stirred for 3 hours.

Next, this was left overnight as such, the supernatant was removed by decantation, and deionized water (30 g) was added thereto, slowly stirred, then statically kept as such, the supernatant was again removed by decantation, then 5% polyvinyl alcohol solution (PVA217, by Kuraray) (10 g) was added thereto, and this was controlled to have a pH of 7.5 with aqueous 1% ammonia solution added thereto to give a solution of capsules (C1).

### Example 3

### Production of Display Device (H1) and Evaluation of Display Properties Thereof

An ITO electrodes-fitted PET film (resistivity 10 Ω/square, special order product, thickness 100 μm, cross direction 140 mm), as patterned as in FIG. 2, was used. In this, the ITO electrodes were disposed at intervals of 5 mm in the longitudinal direction of the PET film in such a manner that a blank of 20 mm wide could remain at one side edge in the cross direction of the PET film and a blank of from 0 to 20 mm wide could remain at the other side edge thereof. The ITO electrode was nearly rectangular, having a size of 100×55 mm except the part corresponding to a lead electrode, and the lead electrode part was nearly rectangular, having a size of 20×5 mm.

Using a wire bar (#56 wire bar, special order product), the capsule solution (C1) produced in Example 2 was continuously applied onto it so that the coating amount could be 98 cc/m², and then the coating film of about 5 mm wide at both side edges of the support was removed by suction through a nozzle (described in JP-A 7-299410). Next, this was dried at 80° C. for 5 minutes, thereby giving a display layer member having a capsule layer formed thereon in a mode of continuous coating on the ITO electrodes-fitted PET film. In this, the ITO electrodes were all covered with the capsule layer except the part corresponding to a lead electrode, as in FIG. 2. The coating width of the capsule layer was 130 mm, and the capsule layer was so disposed as to keep a blank of 5 mm wide remaining in both side edges in the cross direction of the PET film.

The web-like coated product was cut to give a piece surrounded by a thick line as in FIG. 2, then an ITO electrode-fitted PET film (resistivity 10 Ω/square, special order product, thickness 100 μm), to which an adhesive had been applied in a thickness of 3 μm, was laminated on it in such a manner that the parts corresponding to the lead of the display layer member could not overlap with each other, as in FIG. 3, thereby giving a display device (H1) of the invention.

While a voltage of 10 V with a rectangular wave of 1 Hz was applied between the facing ITO electrode surfaces, and white light was applied to it at an angle of 45 degrees to the PET film surfaces, and the reflection density in the direction of 90 degrees to the PET film surfaces was measured.

The reflection density changed depending on the rectangular wave applied. The reflection density at an application voltage of minus 15 V was 2%, and that at an application voltage reversed to plus 15 V was 38%, and the contrast ratio was 19. The device thus had excellent display characteristics.

Next, the application voltage was increased up to 200 V, at which the device could be still driven with no trouble of electrode-to-electrode short-circuiting or sparking.

### Example 4

In Example 3, an area of 5±2 mm wide was ensured for the bare lead electrode part. Example 4 differs from Example 3 in that the suction remover for the superfluous coating liquid was not used in the bar coating; and in this, an area of at most 1 mm wide was formed in a ratio of 3/20 for the bare lead electrode part. This case required peeling away the capsule layer for ensuring the electric conductivity of the device, but was nearly the same as in Example 3 in point of the display characteristics and the pressure resistance.

### Example 5

### Encapsulated Cholesteric Liquid-Crystal System

(Preparation of Capsules (RC1) with Red-Selective Reflection)

66.0% by weight of a nematic liquid crystal E48 (by BDH), 17.0% by weight of a chiral agent CB15 (by Merck) and 17.0% by weight of CE₂ (by Merck) were dissolved under heat, and then restored to room temperature to give a cholesteric liquid crystal capable of selectively reflecting red light.

Gelatin (3.2 g) was put into a 200-ml container equipped with a stirrer, a dropping funnel and a pH meter, deionized water (60 g) was added thereto to dissolve gelatin, and gradually stirred with heating up to 40° C. so as not to engulf bubbles thereinto; and the above-mentioned cholesteric crystal (6.0 g) was dropwise added to it through the dropping funnel, taking 5 minutes, and after the addition, this was further kept stirred for 30 minutes.

Next, a solution of gum arabic (3.2 g) dissolved in deionized water (16 g) was added to it, then controlled to have a pH of 4 with aqueous 10% acetic acid added thereto, and cooled to 10° C.; and aqueous 25% glutaraldehyde solution (1.6 ml) was added thereto, then slowly restored to room temperature, and kept stirred for 3 hours.

Next, this was left overnight as such, the supernatant was removed by decantation, and deionized water (48 g) was added thereto, slowly stirred, then statically kept as such, the supernatant was again removed by decantation, then 5% gelatin solution (20 g) was added thereto, and this was controlled to have a pH of 7.5 with aqueous 1% ammonia solution added thereto to give a solution of capsules (RC1) with red-selective reflection.

(Preparation of Capsules (GC1) with Green-Selective Reflection)

62.0% by weight of a nematic liquid crystal E48 (by BDH), 19.0% by weight of a chiral agent CB15 (by Merck) and 19.0% by weight of CE₂ (by Merck) were dissolved under heat, and then restored to room temperature to give a cholesteric liquid crystal capable of selectively reflecting green light.

Using the cholesteric liquid crystal and in the same manner as in the above, a solution of capsules (GC1) with green-selective reflection was produced.

(Preparation of Capsules (BC1) with Blue-Selective Reflection)

58.0% by weight of a nematic liquid crystal E48 (by BDH), 21.0% by weight of a chiral agent CB15 (by Merck) and 21.0% by weight of CE₂ (by Merck) were dissolved under heat, and then restored to room temperature to give a cholesteric liquid crystal capable of selectively reflecting blue light.

Using the cholesteric liquid crystal and in the same manner as in the above, a solution of capsules (BC1) with blue-selective reflection was produced.

### (Production of Display Device (H2) and Evaluation of Display Properties Thereof)

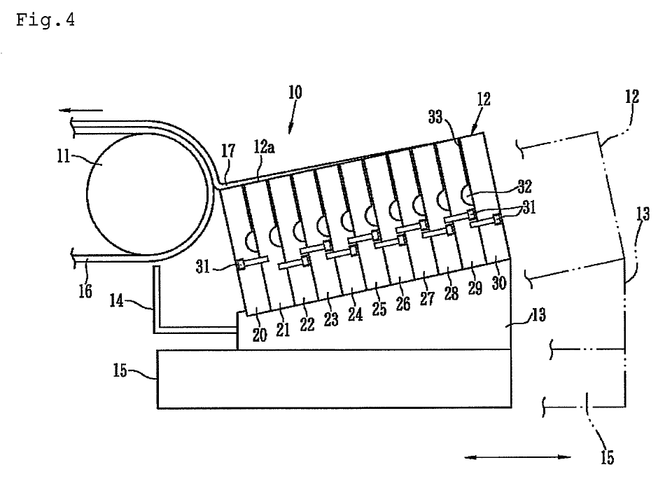

Using a simultaneous three-layer coating, slide bead coater shown in FIG. 4, solutions prepared by individually diluting 1.05 times the above-mentioned red capsule (RC1) solution and the above-mentioned green capsule (GC1) solution and a dilution prepared by diluting 1.1 times the above-mentioned blue capsule (BC1) solution were, as coating liquids for lowermost layer, middle layer and uppermost layer, respectively, simultaneously applied onto a patterned ITO electrode-fitted PET film (TORAY's High Beam NX01, having a thickness of 125 μm and a with of 18 cm) in a multilayer simultaneous coating mode in such a manner that an area of 5 mm wide at both side edges of the support could be kept uncoated. The coating thickness of each layer was 35 μm.

The coating width of the three layers was nearly the same, and the coating thickness did not increase at the side edges, and therefore, the entire coating width was usable as a display device.

This was dried while kept at 5° C. after the coating, and then further dried at 60° C. for 10 minutes, thereby giving a display member having the three BGR capsule layers formed by continuous coating on the ITO electrode-fitted PET film.

In this case, the patterned ITO electrode was entirely coated with the capsule layers, except the part corresponding to a lead electrode, like in Example 3.

Like in Example 3, the web-like coated product was cut into pieces each including the part corresponding to a lead electrode therein. A counter electrode film, ITO electrode-fitted PET film (having a thickness of 125 μm) coated with a black polyimide BKR-105 (by Nippon Kayaku) on the side opposite to the ITO electrode was prepared, and this was coated with an adhesive in a thickness of 5 μm on the ITO electrode. The counter electrode film was laminated with the BGR-coated ITO electrode-fitted PET film produced herein, in such a manner that the ITO electrodes of the two could face to each other and the parts corresponding to lead electrode of the two could not overlap with each other, as in FIG. 3, thereby producing a color display device (H2) of the invention.

With increasing the voltage given thereto from 250 V, a 50 Hz/200 ms-periodic rectangular wave was applied between the facing two ITO electrode faces, and white light was applied to it in the direction of 45 degrees to the PET film surfaces, and the reflection density in the direction of 90 degrees to the PET film surfaces was measured.

The reflection density and the color changed depending on the voltage applied. Up to 300V, the device gave black display; at 430 V, it gave red display; at 530 V, it gave yellow display; and at 780 V, it gave white display. The reflection density at 550 nm was 5% at the time of black level of display, and was 22% at the time of while level of display; and the contrast ratio was 4.4. Thus, the device had excellent display characteristics.

Next, the application voltage was increased up to 850 V, at which the device could still give white display with no trouble of electrode-to-electrode short-circuiting or sparking.

The slide bead coater used herein in carrying out the invention is described with reference to FIG. 4. The slide bead coater 10 used herein comprises a coating backup roll 11, a coating die 12, a die stand 13, a vacuum chamber 14 acting also as a liquid receiver and a moving stand 15. The moving stand 15 can horizontally move between the recession position (shown by two-dot lines) spaced from the coating backup roll 11, and the coating position (shown by full lines) kept near to the coating backup roll 11. Accordingly, during coating, the moving stand 15 is set in the coating position. A web 16 is conveyed while wound around the coating backup roll 11 and, and a coating liquid 17 is applied to the traveling web 16, from the slide surface 12a of the coating die 12.

The coating die 12 is composed of a large number of blocks, 20 to 30, longitudinally set up, laterally arrayed and fastened by means of bolts 31. In this Example, three blocks, 20 to 22 were used, and a manifold 32 and a slot 33 were fitted to the facing surfaces thereof, thereby making it possible to attain simultaneous three-layer coating with the coater.

### Example 6

A display device was produced and evaluated in the same manner as in Example 3, for which, however, ITO electrodes were formed at intervals of less than 1 mm in the longitudinal direction of the PET film. Of the cut pieces, those having an electrode layer part kept bare at the side edge of the support film were in a ratio of 7/20. Laminated with a counter electrode, the electrode was formed into a display device. Two of the thus-produced display devices were short-circuited and failed in display; however, the remaining 18 samples were nearly on the same level as those in Example 3 in point of the display characteristics and the pressure resistance.

### Comparative Example 1

A web-like coated sample was produced in the same manner as in Example 3, for which, however, a continuous ITO electrode was formed in the longitudinal direction of the PET film with no interval therein. When cut, the edges of the electrode layer of the cut samples were laid bare. Stuck to a counter electrode, the samples were formed into display devices; however, 4/5 of the thus-produced devices were short-circuited and failed in display.

### Example 7

In Example 5, the lowermost layer, the middle layer, and the outermost layer were formed by successive coating. In this case, the coating position of each layer shifted by about 1 mm, and the part of 8 mm from each side edge (5 mm from each side edge was not coated) was not coated with all the three layers, but could attain incomplete display. However, the other part of the device produced herein was on the same level as in Example 5 in point of the display characteristics and the pressure resistance.

### Example 8

A display device was produced in the same manner as in Example 3, for which, however, a transparent conductive film having meshes of silver particles formed by screen printing on an ITO particle layer, as in JP-T (reissued) 2004-035665, was used in place of the patterned ITO electrode-fitted PET film. The display device required a driving voltage of 30 V, but was good like that in Example 3.

### INDUSTRIAL APPLICABILITY

The invention has made it possible to produce, according to a simple method of continuous coating on a web-like substrate, a large-area electrode material having an electrode layer in which a part of the electrode layer is laid bare (for example, for a lead part for wiring for electric interconnection) and the other part thereof is laminated with at least one functional layer. As a result, the invention has made it possible to produce a large quantity of electronic papers (electrophoretic system, powder flow system, toner display, cholesteric liquid-crystal system, dual-stabilized nematic liquid-crystal system). Specifically, the invention has made it possible to produce a large quantity of electrode material at low costs.

When the web-like electrode material of the invention is cut, it gives individual electrode materials. Accordingly, the individual electrode materials have constant quality with no fluctuation, and as a result, the electronic devices to be produced from them may have constant quality with no fluctuation.

In particular, when the web-like electrode material of the invention is cut into individual electrode materials each having a size larger than the electrode therein, the part of the thus-cut electrode material except the projection of the electrode thereof, which is to be a lead electrode part, is not laid bare. The electrode material of the type may be stuck to a counter electrode, and in that manner, a large quantity of electrodes and display devices free from trouble of short-circuiting, current leakage or the like can be produced on a mass-production scale at low costs.

In the invention, the coating film thickness can be uniform not forming a thick part at the side edges of the coated film, and therefore, the pressure resistance of the display device to be constructed by sticking a counter electrode to the electrode material of the invention can be enhanced, and the display device thus constructed is free from trouble of electrode disruption, etc.

Further, electronic devices constructed by the use of the electrode material produced according to the production method of the invention are free from trouble of short-circuiting, current leakage, etc.

Moreover, the electrode material prepared by cutting the web-like electrode material of the invention may have a uniform thickness (not having a thick area at the side edges thereof). Therefore, the member constructed by sticking the electrode material of the invention to a counter electrode is resistant to pressure (with no trouble of electrode breakage). In addition, in the electronic device of the invention, the thickness of the electrode layer and the functional layer is uniform, and therefore, when the device is used in producing thin-wall appliances, the produced thin-wall appliances may have good appearance since their surface may be smooth as having neither projections nor depressions owing to thickened side edges of the constitutive member.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 321297/2007 filed on Dec. 12, 2007, which is expressly incorporated herein by reference in its entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A web-like electrode material comprising a web-like substrate, a plurality of electrode layers and a functional layer provided in that order, wherein:
the plurality of electrode layers are disposed in series with blanks kept remaining in both side edges in the cross direction of the substrate and between adjoining electrode layers in the longitudinal direction of the substrate each with a predetermined regularity, and
the functional layer is disposed to cover a part of each electrode layer and leave the other part of each electrode layer bare.

2. The web-like electrode material according to claim 1, wherein the plurality of electrode layers have the same shape.

3. The web-like electrode material according to claim 1, wherein the electrode layer has a shape composed of a nearly rectangular part and a projection continuing from the nearly rectangular part, and wherein the functional layer is so disposed that at least a part of the projection is kept bare.

4. The web-like electrode material according to claim 3, wherein the functional layer completely covers the electrode layer except the projection thereof.

5. The web-like electrode material according to claim 1, wherein the electrode layers are disposed at intervals of from 1 to 300 mm in the longitudinal direction of the substrate.

6. The web-like electrode material according to claim 1, wherein the electrode layers are disposed with a blank of at least 5 mm each in both side edges in the cross direction of the substrate.

7. The web-like electrode material according to claim 1, wherein the electrode layer is composed of a nearly rectangular part of 10 to 3000 mm×5 to 2000 mm, and a nearly rectangular projection of 1 to 300 mm×2 to 200 mm continuing from it.

8. The web-like electrode material according to claim 1, wherein the functional layer is provided according to a wet coating process.

9. The web-like electrode material according to claim 1, wherein at least two functional layers are provided.

10. The web-like electrode material according to claim 9, wherein at least two functional layers are provided by simultaneous coating.

11. The web-like electrode material according to claim 9, wherein the width of at least two functional layers is nearly the same.

12. An electrode material produced by cutting the web-like electrode material of claim 1 between the electrode layers in the cross direction of the substrate.

13. An electrode produced by providing at least an electrode layer on the surface of the functional layer of the electrode material of claim 12.

14. An electronic device comprising the electrode material of claim 12.

15. The electrode device according to claim 14, which is a display device or a solar cell.

16. A method for producing a web-like electrode material comprising a web-like substrate, a plurality of electrode layers and a functional layer provided in that order, which comprises disposing plural electrode layers in series with blanks kept remaining in both side edges in the cross direction of the substrate and between the adjoining electrode layers in the longitudinal direction of the substrate each with a predetermined regularity, and disposing the functional layer by continuous coating in the longitudinal direction of the substrate so as to keep a part of each electrode layer laid bare.

17. The method according to claim 16, wherein the plurality of electrode layers have the same shape.

18. The method according to claim 16, wherein the electrode layer has a shape composed of a nearly rectangular part and a projection continuing from the nearly rectangular part, and wherein the functional layer is so disposed that at least a part of the projection is kept bare.

19. The method according to claim 18, wherein the functional layer is formed to completely cover the electrode layer except the projection thereof.

20. The method according to claim 16, wherein the electrode layers are disposed at intervals of from 1 to 300 mm in the longitudinal direction of the substrate.

21. The method according to claim 16, wherein the electrode layers are disposed with a blank of at least 5 mm each in both side edges in the cross direction of the substrate.

22. The method according to claim 16, wherein the electrode layer is composed of a nearly rectangular part of 10 to 3000 mm×5 to 2000 mm, and a nearly rectangular projection of 1 to 300 mm×2 to 200 mm continuing from it.

23. The method according to claim 16, wherein the functional layer is provided according to a wet coating process.

24. The method according to claim 16, wherein at least two functional layers are provided.

25. The method according to claim 24, wherein at least two functional layers are provided by simultaneous coating.

26. The method according to claim 24, wherein the coating width of at least two functional layers is nearly the same.

27. The method according to claim 16, wherein the functional layer is formed by bar-coating to be attained by the use of a suction unit capable of drawing out the superfluous coating liquid at the edges of the substrate in accordance with the coating width of the layer.

28. The method according to claim 16, wherein the functional layer is formed by bar-coating to be attained by the use of a step roll.

29. The method according to claim 16, wherein the electrode layers are provided by patterning.

30. The method according to claim 16, wherein the electrode layers are provided by coating.

31. The method according to claim 16, to produce a web-like electrode material comprising a web-like substrate, an electrode layer and a functional layer provided in that order, wherein a plurality of electrode layers are disposed in series with blanks kept remaining in both side edges in the cross direction of the substrate and in the longitudinal direction thereof each with a predetermined regularity, and the functional layer is disposed by continuous coating in the longitudinal direction of the substrate, and a part of each electrode layer is laid bare.
